(19) United States
(12) Patent Application Publication
(10) Pub. No.: US 2026/0254296 A1
(43) Pub. Date: Aug. 27, 2026

(54) STATOR SEALING MEMBER

(71) Applicant: SAFRAN ELECTRICAL & POWER, Pitstone Buckinghamshire (GB)

(72) Inventors: Anthony KELLY, Pitstone Buckinghamshire (GB); Mark CRAIG, Pitstone Buckinghamshire (GB)

(21) Appl. No.: 19/161,408

(22) PCT Filed: Mar. 1, 2024
(86) PCT No.: PCT/EP2024/055444

§ 371 Date: Sep. 2, 2025

(30) Foreign Application Priority Data
Mar. 3, 2023 (GB) 2303201.4

(51) Int. Cl. H02K 1/20; H02K 1/16; H02K 3/34; H02K 5/10; H02K 5/16

(52) U.S. Cl. CPC H02K 1/20; H02K 1/16; H02K 3/345; H02K 5/10; H02K 5/16; H02K 2201/03; H02K 2205/09

(57) ABSTRACT

An electric machine for use with an aircraft engine. The electric machine includes a housing having at least one structural member, a rotor, a stator core supported by the at least one structural member and at least one end winding extending from the stator core. A cooling path is configured to circulate coolant around the stator core and to the end winding. An annular sealing member is arranged at a first end face of the stator core and forms a seal against the first end face of the stator core. It has a radially-facing surface which extends axially away from the first end face to form a seal with the structural member, so as to direct coolant away from an air gap between the stator core and the rotor. A stator assembly and a related annular sealing member.

### TECHNICAL FIELD

The invention relates to a stator assembly for an electric machine for use in aircraft. In particular, the invention relates to a seal arrangement for a liquid cooled stator and related methods of assembly.

### BACKGROUND OF THE INVENTION

Electric machines can be used for electrical power generation or to provide motive power in aircraft. An electric machine is typically formed of an assembly of magnetic circuit components comprising a stator, and a rotor configured to rotate within a bore of the stator. As is well known, rotation of the rotor relative to the stator causes interaction of the magnetic field generated by the rotor with windings provided on the stator, generating an induced electromotive force (EMF) and/or electrical current. In a permanent magnet generator, the rotor's magnetic field is produced by permanent magnets, which induces an AC voltage in the stator windings as the stator windings pass through the moving magnetic field of the permanent magnet. In a motor, a rotating AC current supplied to the windings of a stator can induce torque in a rotor.

The performance of conventional stators can be hindered by the inefficiency with which heat generated in the windings is transferred away from the stator teeth.

There exists a need for an improved stator assembly and related method of manufacture.

### SUMMARY OF THE INVENTION

According to an aspect of the invention, there is provided an electric machine for use with an aircraft engine comprising any or all of the following features:
a housing having at least one structural member,
a rotor configured to rotate relative to the housing about a longitudinal axis,
a stator core arranged in the housing and supported by the at least one structural member,
at least one end winding extending from the stator core,
a cooling path configured to circulate coolant around the stator core, the cooling path being in fluid communication with the at least one end winding, and
an annular sealing member arranged at a first end face of the stator core, the annular sealing member forming a seal against the first end face of the stator core and comprising a radially-facing surface which extends axially away from the first end face to form a seal with the at least one structural member, so as to direct coolant away from an air gap between the stator core and the rotor.

A plurality of windings may be arranged in a plurality of slots of the stator core. The plurality of windings may be configured to be in fluid communication with the coolant path. The plurality of slots may each comprise a slot liner. The slot liner may be configured to receive at least one of the plurality of windings. The slot liner may extend axially beyond the first end face of the stator core so as to be received by the annular sealing member.

The rotor may be rotatably mounted in the housing by at least one bearing. The bearing may be a roller bearing. The at least one bearing may be arranged between the rotor and the at least one structural member so as to permit rotation of the rotor relative to the housing.

The air gap between the rotor and the stator core may have a radial length of less than 1 mm, preferably less than 0.9 mm, preferably less than 0.8 mm, preferably less than 0.7 mm.

According to another aspect of the invention embodiment, there is provided a stator assembly for an electric machine. The electric machine may be the electric machine described hereinabove. It will be understood that any or all features described in relation to the stator assembly may be comprised in the electric machine or vice-versa. The stator assembly may comprise any or all of the following features:
a stator core disposed around a longitudinal axis, the stator core comprising an annular back iron and a plurality of teeth extending radially toward the longitudinal axis, the plurality of teeth defining a plurality of stator slots configured to receive a plurality of windings, and
an annular sealing member comprising:
   an axially-facing surface arranged against a first end face of the stator core, the axially-facing surface having openings aligned with the plurality of stator slots, the openings being configured to receive at least one end winding of the plurality of windings, and
   a radially-facing surface extending away from the first end face, so as to be able to seal against one or more structural members of the electric machine when assembled therewith.

The electric machine may be suitable for use in an aircraft. In particular, the electric machine can be configured for use with an aircraft engine, for example to generate electrical power when being driven by an output shaft of the aircraft engine. The electric machine may be a high speed electric machine, which may have a rotational speed of approximately 45,000 revolutions per minute (rpm). In such high speed electric machines, the speed of the outer diameter of the rotor is close to the speed of sound. As such, performance of the electric machine can be improved by minimising or preventing coolant from the stator cooling circuit from entering the air gap between the rotor and the stator core, which could otherwise lead to churning, hydro-mechanical losses and windage losses.

Previous attempts at addressing this problem of coolant in the air gap include forming a sleeve around the entire internal bore of the stator, wherein the sleeve extends axially between the stator and the rotor. However, this takes up space in the air gap, meaning that the distance between the stator core and the rotor must be increased to accommodate the sleeve, which can hinder efficiency. By providing an annular sealing member in accordance with the invention, a stator assembly can be produced which improves the performance of an electric machine into which it is fitted by decreasing the size of the air gap while preventing coolant from entering the air gap. Furthermore, these advantages can be realised without forming a separate shell around each end face of the stator core which would otherwise take up additional space in the electric machine. By forming the annular sealing member with a radially-facing surface to seal against a structural member of the electric machine, the space in the electric machine is used more effectively.

An axially-facing surface of the annular sealing member may have openings aligned with the plurality of stator slots, the openings being configured to receive at least one end winding of the plurality of windings. The openings may be distributed evenly around the angular extent of the annular sealing member. The number of openings may be greater than or equal to a number of stator slots. This has the advantage of providing an improved stator assembly which can be compatible with a range of different winding arrangements. At least one winding of the stator assembly may extend away from the first end face of the stator core to define at least one end winding. At least one end winding may be received by at least one of the openings. The number of the at least one end windings may be greater than or equal to the number of openings. Each of the openings may be configured to seal around a respective end winding of the at least one end windings so as to prevent transfer of coolant through the opening. The windings may be formed of multiple turns of wire or may be formed of cast conductors, which may have a rectangular cross-section.

The axially-facing surface can be annular so as to correspond to an annular end face of the stator core. The axially-facing surface may be connected to the first end face by an adhesive. The adhesive may be epoxy resin. The adhesive may be applied between the axially-facing surface and the first end face in such a way as to prevent coolant from flowing between the axially-facing surface and the first end face. The radially-facing surface can be annular so as to correspond with a structural member of the housing. The radially-facing surface defines a bore which can extend the stator bore in an axial direction.

The axial extent of the radially-facing surface may define a length and the radial extent of the axially-facing surface may define a width, and the width may be greater than or equal to the length. The stator assembly may comprise a drain passage. The drain passage may be arranged between the annular sealing member and the stator core. The drain passage may be arranged at a bottom portion of the stator core. It will be understood that the bottom portion of the stator core can correspond to the lowermost portion of the stator core when incorporated into the electric machine. The drain passage may be arranged to provide a gap between the first end face of the stator core and the axially-facing surface of the annular sealing member. The drain passage may comprise a recess, channel or notch in the axially-facing surface. The drain passage may be defined by a reduced length portion of the annular sealing member. The angular extent of the drain passage may be less than 60 degrees, or less than 50 degrees, or less than 40 degrees, or less than 30 degrees.

The stator assembly may further comprise a second annular sealing member. The second annular sealing member may be arranged at a second end face of a stator core being on the opposite end of the stator core to the first end face. The second annular sealing member may have any or all of the features described in relation to the above-mentioned annular sealing member arranged against the first end face. The second annular sealing member may comprise an axially-facing surface arranged against the second end face. The second annular sealing member may comprise a radially-facing surface which may extend away from the second end face so as to be able to seal against one or more structural members of the electric machine when assembled therewith.

At least one of the plurality of slots may comprise a slot liner. The slot liner may be configured to receive a respective winding of the plurality of windings. A gap between at least one pair of adjacent stator teeth may comprise a varnish. This has the advantage of further reducing windage losses.

According to another aspect of the invention, there is provided an annular sealing member for the stator assembly as described above. The annular sealing member may comprise an axially-facing surface configured to be arranged at a first end face of the stator core. The axially-facing surface may have openings configured to align with the plurality of stator slots. The annular sealing member may further comprise a radially-facing surface. The radially-facing surface may be configured to extend away from the first end face so as to be able to seal against one or more structural members of the electric machine when assembled therewith.

According to another aspect of the present invention, there is provided an aircraft comprising the stator assembly, or the annular sealing member, or the electric machine as described hereinabove.

### BRIEF DESCRIPTION OF THE DRAWINGS

Further features and advantages of the present invention will become apparent from the following description of embodiments thereof, presented by way of example only, and by reference to the drawings, in which:

FIG. 1 is a partial cross-section of an electric machine according to an embodiment;

FIG. 2 is a perspective view of a stator assembly according to an embodiment;

FIG. 3 is a perspective view of an annular sealing member according to an embodiment;

FIG. 4 is a perspective view of part of a stator assembly according to an embodiment;

FIG. 5 is a perspective view of part of a stator assembly according to an embodiment;

FIG. 6 is a schematic diagram of an aircraft according to an embodiment.

### DETAILED DESCRIPTION

A stator assembly is disclosed herein in the context of an electric machine suitable for use in an aircraft. An electric machine typically includes a stator having a plurality of magnetisable stator teeth extending from a back iron, and a rotor configured to rotate about a longitudinal axis of the stator. The stator teeth define a plurality of slots configured to receive conductors, for example in the form of conductive (e.g. copper) windings. The rotor of such an electric machine includes a plurality of magnetisable elements such as windings or permanent magnets. As such, the electric machine formed from the stator and the rotor can act as a generator when the rotor rotates within the stator thereby inducing an electric current in the windings of the stator, and can also act as an electric motor when an electric current provided in the windings induces rotation of the rotor.

The stator assembly disclosed herein has a stator core which is cooled by a cooling path when incorporated into an electric machine. The cooling path surrounds the stator core such that coolant, such as oil, may be in fluid communication with the stator core so as to transfer generated heat away from the stator core. The cooling path may also run through at least a portion of the stator core. The stator assembly has a number of end windings located in an overhang cavity of the longitudinal ends of the stator core. The cooling path is configured to provide coolant to such end windings, for example by flooding the overhang cavity. The overhang cavity is defined by a structural member of the housing in which the electric machine is contained. The structural member is named as such because it provides structural support to the stator assembly and may also act to support the bearings which permit the rotation of the rotor.

A sealing member is provided to seal the structural member against the stator core. The sealing member is annular and is arranged at the longitudinal end of the stator core so as to form a barrier around the entire angular extent of the stator core to prevent coolant from escaping the overhang cavity. The annular sealing member has an axial projection which is configured to extend axially outwards from the stator core in order to meet the structural member at the sealing interface. The axial projection defines a radially-facing surface to interface with the structural member. The annular sealing member also has a radial portion which has an axially-facing surface to interface with at least a portion of the longitudinal end face of the stator core. The radial portion may have a plurality of openings in order to accommodate the end windings extending from the stator slots.

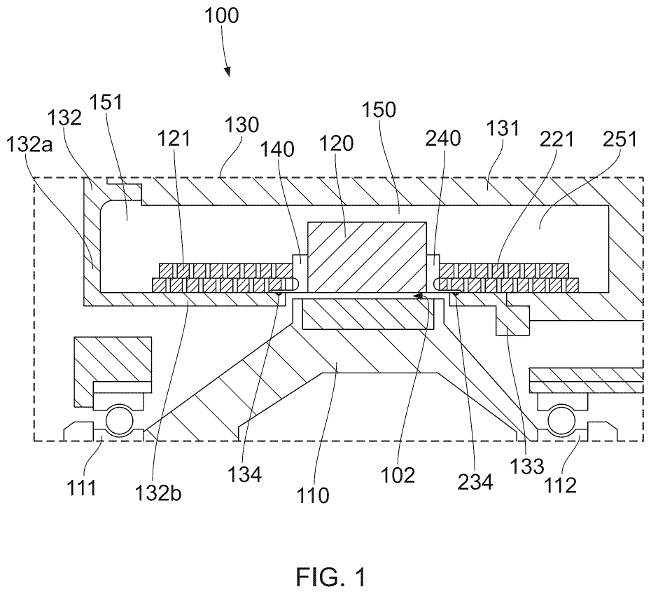

FIG. 1 illustrates a cross-section of an electric machine 100 according to an embodiment. The electric machine 100 comprises a chassis or housing 130. The housing 130 comprises one or more structural members 131, 132, 133. The electric machine 100 further comprises a stator assembly including stator core 120 supported by the housing 130, in particular by at least one structural member 131, 132, 133 of the housing 130. In the arrangement shown, the stator core 120 is supported by a first structural member 131. The first structural member 131 is substantially tubular and surrounds an outer circumference of the stator core 120.

The electric machine 100 further comprises a rotor 110 configured for rotation about a longitudinal axis. The rotor 110 is disposed within the stator core 120 and separated therefrom by an air gap 102. The air gap 102 may be approximately 0.7 mm in the radial direction. The rotor 110 is rotatably mounted in the housing 130, for example by one or more bearings 111, 112. The one or more bearings 111, 112 can be supported by one or more structural members 131, 132, 133 of the housing 130. In the arrangement shown, a first end of the rotor 110 is fixed to an inner race of a first roller bearing 111 and the outer race of the first roller bearing 111 is fixed to a second structural member 132 of the housing 130. The second structural member 132 is fixedly connected to the first structural member 131 and is arranged around a first end of the stator core 120. A second end of the rotor 110 is fixed to an inner race of a second roller bearing 112 and the outer race of the second roller bearing 112 is fixed to the first structural member 131. The second roller bearing 112 may also be connected to a third structural member 133.

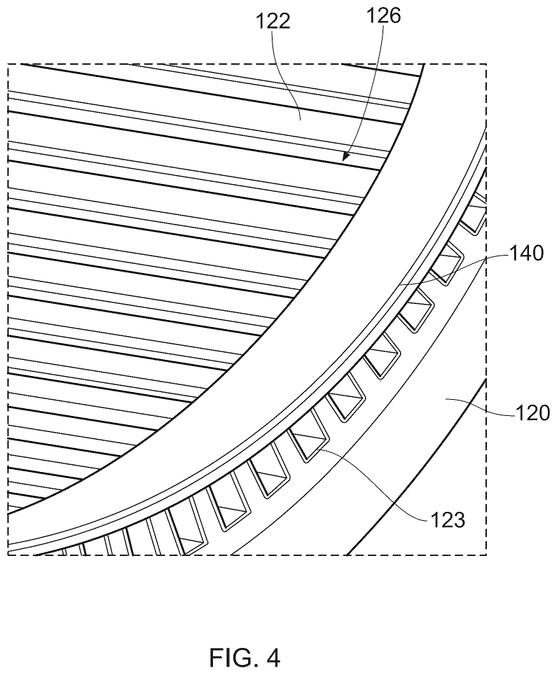

The stator core 120 has an annular back iron and a plurality of teeth 122 (see FIG. 4) extending therefrom in a radially inward direction toward the longitudinal axis. Stator slots are defined between adjacent pairs of teeth 122. The slots are configured to receive conductors in the form of windings which extend longitudinally through the stator core 120. In one embodiment, the stator core 120 comprises 90 slots. The stator core 120 may comprise conductors in a single or a double winding arrangement. For example, each slot can contain two conductors, one being arranged radially inward of the other. In the arrangement shown, the windings extend axially beyond the longitudinal extent of the stator core 120 to form a plurality of end windings. The end windings can be arranged in an overhang cavity which comprises a space at one or both longitudinal ends of the stator core 120. At a first longitudinal end of the stator core 120, a plurality of first end windings 121 are contained within a first overhang cavity 151. At a second longitudinal end of the stator core, the stator assembly may have a plurality of second end windings 221 contained within a second overhang cavity 251. The overhang cavities 151, 251 can comprise substantially annular cavities disposed around the longitudinal axis and arranged at either longitudinal end of the stator core 120.

The overhang cavities 151, 251 may be defined by four surfaces: an outer circumferential surface, an inner circumferential surface, a proximal radial surface (i.e., proximate to the stator core 120) and a distal radial surface. In the illustrated arrangement, the stator core 120, particular the end face thereof, defines the proximal radial surface, while the first structural member 131 provides the outer circumferential surface. The distal radial surface and the inner circumferential surface of the first overhang cavity 151 are defined by the second structural member 132. In particular, the distal radial surface is defined by a radial portion 132a of the second structural member 132, while the inner circumferential surface is defined by an axial portion 132b of the second structural member 132 which extends along the longitudinal axis from the radial portion 132a. The second overhang cavity 251 may be arranged in a similar manner. In some embodiments, such as that shown in FIG. 1, the first structural member 131 can define the outer and inner circumferential surfaces and the distal radial surface.

The electric machine 100 has a cooling circuit for circulating coolant fluid to the stator assembly. In the arrangement shown, the cooling circuit includes a coolant path 150 comprising a passage between the stator core 120 and the housing 130, in particular the first structural member 131 of the housing. The coolant path 150 can be configured to provide coolant around the annular back iron of the stator core and to one or more of the overhang cavities 151, 251.

The stator assembly of the electric machine 100 further comprises an annular sealing member 140. The annular sealing member 140 is configured to provide a seal between the stator core 120 and one or more structural members 131, 132, 133 of the housing 130. In this way, the annular sealing member 140 can provide a barrier to direct coolant in the overhang cavity away from the stator bore and the air gap 102. The annular sealing member 140 may comprise a thermoplastic material such as polyether ether ketone (PEEK). In the arrangement shown, the annular sealing member 140 is disposed against a first end face of the stator core 120 from the first end windings 121 extend. The annular sealing member 140 can be configured to extend the stator bore, i.e. the bore in which the rotor rotates, beyond the longitudinal extent of the stator core 120. In the illustrated arrangement, the annular sealing member 140 comprises an axial projection which extends parallel to the longitudinal axis. Such a projection can extend the stator bore in the axial direction. The axial projection can be provided by a substantially cylindrical portion disposed around the longitudinal axis. In the arrangement shown, the projection extends parallel to the longitudinal axis to interface with the second structural member 132, in particular with the radial portion 132a thereof. A sealing interface can be provided between the annular sealing member 140 and a structural member. In the arrangement shown, the annular sealing member 140 interfaces with the structural member 132 via an O-ring 134.

Any or all features of the electric machine 100 described for the region of the first overhang cavity 151 may be equally applicable to the second overhang cavity 251, where similar reference numerals have been used to denote corresponding features. In the illustrated arrangement, the stator assembly has a plurality of second end windings 221 extending from the second end face. The stator assembly can comprise a second annular sealing member 240 which can interface with a structural member, for example a third structural member 133, of the housing. A sealing interface between the second annular member 240 and the structural member can be provided by an O-ring 234.

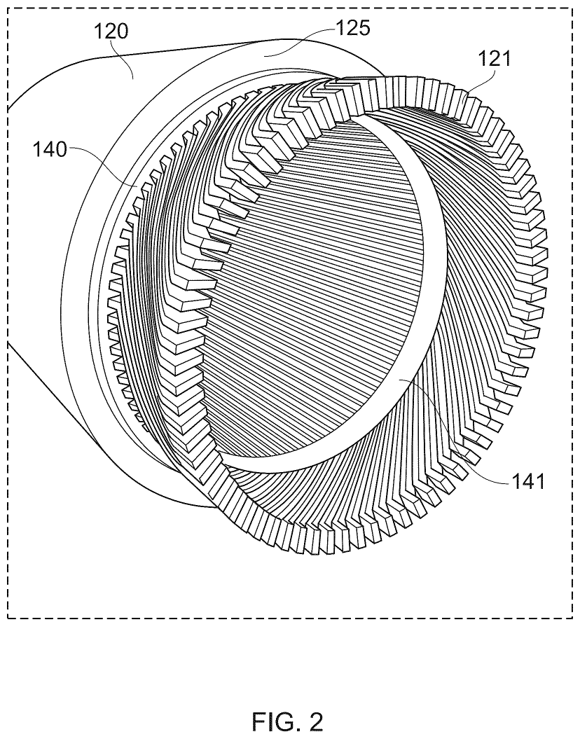

FIG. 2 schematically illustrates a stator assembly according to embodiments of the invention. The stator core 120 comprises a plurality of slots defined between adjacent pairs of teeth. The annular sealing member 140 can be arranged to abut a first end face 125 of the stator core 120. Where it is desired to have the annular sealing member abut the end face between or around the plurality of slots, openings in the annular sealing member can be provided and may be aligned with the plurality of stator slots. In this way, windings of the stator assembly can be inserted such that at least one end winding 121 can be received by an opening of the annular sealing member 140. The openings in the annular sealing member may be arranged to partially surround or completely surround the one or more end windings in the plane of the end face 125.

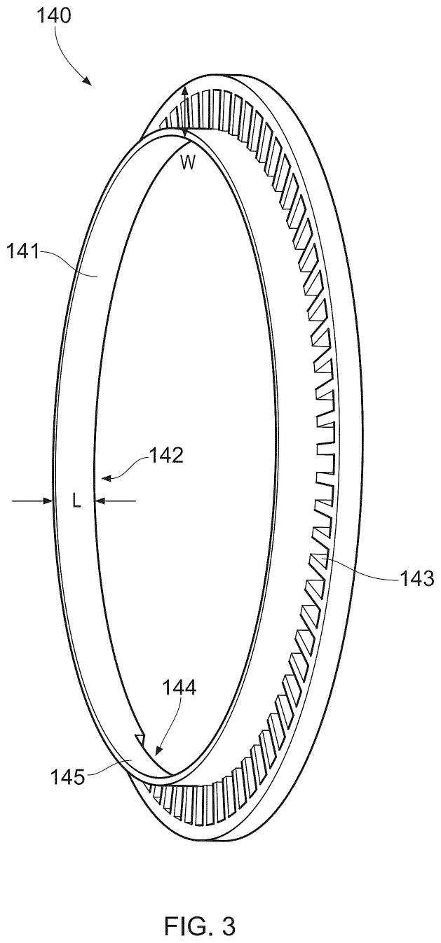

FIG. 3 illustrates an annular sealing member 140 according to embodiments of the invention. The annular sealing member 140 has a radially-facing surface 141, which faces a radial direction with respect to the longitudinal axis of the annular sealing member 140. The radially-facing surface 141 can be provided by an axial projection of the annular sealing member 140, which may have a substantially cylindrical form. The annular sealing member 140 further comprises an axially-facing surface 142, which faces a direction parallel to the longitudinal axis. The axially-facing surface 142 is configured to be arranged against an end face of the stator core 120. The axially-facing surface 142 can be provided on a radially-extending portion of the annular sealing member 140.

The annular sealing member 140 can further be provided with a plurality of openings 143 which can be distributed evenly around the longitudinal axis. The openings 143 can be provided on the axially-facing surface 142 of the annular sealing member 140. The openings can be configured to align with the plurality of stator slots of the stator core 120 so as to be able to receive end windings 121 extending from the stator slots. The openings 143 each provide an axial passage from a first axial end to a second axial end of the annular sealing member 140. In the arrangement shown, each opening 143 comprises a substantially rectangular cavity extending through the thickness of the radial portion of the annular sealing member 140. However, it will be appreciated that the openings 143 may take any other shape so as to be configured to align with the stator slots and/or to receive the end windings 121.

The axial extent of the radially-facing surface 141 defines a length L and the radial extent of the axially-facing surface 142 defines a width W. In the arrangements shown, the width W is greater than the length L. In alternative arrangements of the annular sealing member 140, the width W may be substantially equal to the length L. In further arrangements of the annular sealing member 140, the length L may be greater than the width W.

The annular sealing member 140 can comprise a drain passage 144 configured to allow coolant in the stator bore to flow radially outwards past the annular sealing member 140. In the arrangement shown, the drain passage 144 is provided by a reduced length portion 145 of the annular sealing member 140. The length of the reduced length portion 145 may be approximately 20% shorter than the length L of the radially-facing surface 141. The angular extent of the reduced length portion 145 may be less than 60 degrees, or may be less than 50 degrees, or less than 40 degrees, or less than 30 degrees. In the arrangement shown, the angular extent of the reduced length portion is approximately 40 degrees. In this way, a drain passage 144 can be arranged between the annular sealing member 140 and the stator core 120 at a bottom portion thereof.

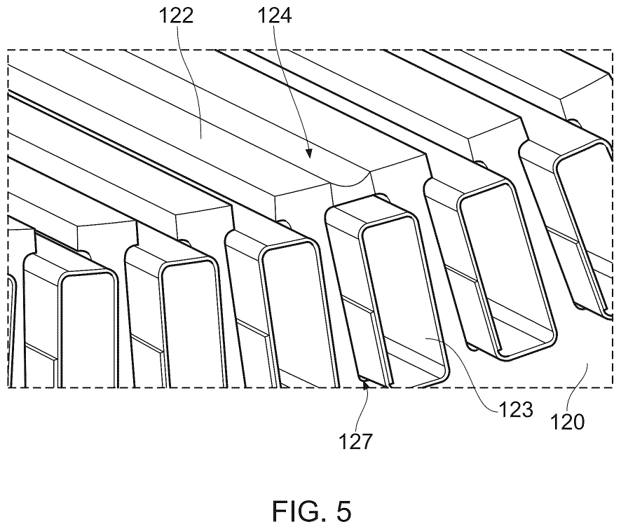

FIGS. 4 and 5 illustrate a part of a stator assembly, which shows the stator core 120 having a plurality of stator teeth 122 and a plurality of stator slots 126 defined between adjacent pairs of stator teeth 122. FIG. 4 also shows the annular sealing member 140 arranged at an end face of the stator core 120. In the arrangement shown, the stator core 120 further comprises a plurality of slot liners 123. The slot liners 123 are configured to receive the windings to provide electrical insulation between the windings and the stator teeth 122. A slot liner 123 defines a cavity which extends longitudinally through a stator slot 126 and can have a shape corresponding to that of the stator slots 126. In the illustrated arrangement, the slot liners 123 are substantially rectangular in cross-section. As shown in FIG. 5, the slot liners 123 can extend longitudinally beyond the axial extent of the stator core 120, so as to be received by the openings 143 of the annular sealing member 140. The size and/or shape of the slot liners 123 may correspond to that of the openings 143 in order to minimise the gap between an outer surface of the slot liners 123 and an inner surface of the openings 143.

As shown in FIG. 5, a channel 127 may be formed between the outer surface of a slot liner 123 and an inside surface of a tooth 126. Without the annular sealing member 140, coolant from the overhang cavity could flow through the channel 127 and exit the stator core 120 in a radially inward direction into the stator bore. In order to prevent this, the annular sealing member 140 can be configured to form a seal around the slot liners 123. This may be achieved by providing a sealant between the outer surface of a slot liner 123 and the inner surface of an opening 143.

In some embodiments, the stator assembly can be configured to prevent coolant from entering the slot liners 123. This may be achieved by sealing the space between the inner surface of the slot liners 123 and the outer surface of the end windings in the region of the annular sealing member 140.

In other embodiments, the stator assembly can be configured to permit coolant to flow longitudinally through the stator slots 126 in order to be in fluid communication with the windings in the slots 126. In this respect, the windings can be arranged within the slot liners 123 and within the openings 143 of the annular sealing member 140 in such a way as to permit coolant to flow between the overhang cavity 151 and the stator slots 126, via a channel between the outer surface of a winding and the inner surface of a slot liner 123.

During operation of the electric machine 100, coolant may weep out of the slot liners 123 and into the stator bore, such that coolant may be present in the air gap 102. In order to further improve the ability of the stator assembly to keep coolant away from the air gap 102, a varnish 124 can be applied to the inner circumferential surface of the stator core 120 so as to close the gap between adjacent pairs of teeth 122. In this way, coolant which may have leaked out of the slot liner 123 into the channel 127 between the slot liner 123 and the stator teeth 122 can still be prevented from entering the air gap 102 by the varnish 124.

A method of applying the varnish is also provided. The method may comprise an applying step of applying air dry varnish with a paint brush to at least part of the longitudinal extent of the slots 126. The method may further comprise a step of wiping the surface with isopropyl alcohol (IPA) in order to form a smooth inner diameter of the stator bore. In order to prevent varnish from dripping out of the slots, the method may be performed on a first group of adjacent slots, and then repeated for remaining groups of adjacent slots. For example, for a stator core having 90 slots, the method may be performed on 15 adjacent slots, before being repeated five more times until varnish has been applied to all slots.

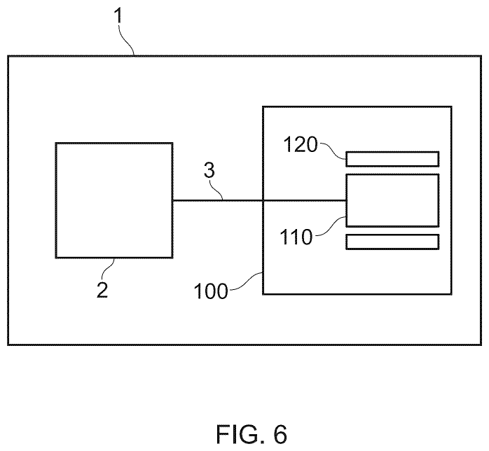

FIG. 6 is a schematic diagram illustrating an aircraft 1. The aircraft 1 comprises a driving or driven element 2 and an electric machine 100 connected to the driven element 2 by a drive shaft 3. The electric machine 100 comprises the stator core 120 of the stator assembly and the rotor 110. The rotor 110 can be connected to the drive shaft 3 and configured to rotate within the stator core 120.

Various modifications, whether by way of addition, deletion and/or substitution, may be made to all of the above described embodiments to provide further embodiments, any and/or all of which are intended to be encompassed by the appended claims.

1. An electric machine for use with an aircraft engine comprising:
a housing including at least one structural member,
a rotor configured to rotate relative to the housing about a longitudinal axis,
a stator core comprising a stator bore, and being arranged in the housing and supported by the at least one structural member,
at least one end winding extending from the stator core,
a cooling path configured to circulate coolant around and/or through at least a portion of the stator core, the cooling path being in fluid communication with the at least one end winding, and
an annular sealing member arranged at a first longitudinal end face of the stator core, the annular sealing member including an axially-facing surface interfacing with and forming a seal against at least a portion of the first longitudinal end face of the stator core and comprising a radially-facing surface which extends axially away from the first end face to form a seal with the at least one structural member, so as to direct coolant away from an air gap between the stator core and the rotor;
wherein the annular sealing member comprises a drain passage configured to allow coolant in the stator bore to flow radially outwards past the annular sealing member.

2. The electric machine according to claim 1, wherein the rotor is rotatably mounted in the housing by at least one bearing, the at least one bearing being connected between the rotor and the at least one structural member.

3. The electric machine according to claim 1, wherein the air gap has a radial length of less than 1 mm.

4. The electric machine according to claim 1, wherein the annular sealing member further comprises an axially-facing surface arranged against the first end face of the stator core, the axially-facing surface defining openings aligned with a plurality of slots of the stator core, the plurality of slots being configured to receive a plurality of windings, and the at least one end winding being received by at least one of the openings.

5. The electric machine according to claim 4, wherein each of the openings is configured to seal around a respective end winding of the at least one end windings, so as to prevent transfer of coolant through the openings.

6. The electric machine according to claim 4, wherein at least one of the plurality of slots comprises a slot liner configured to be received by one of the openings, the slot liner being configured to receive a respective winding of the plurality of windings.

7. The electric machine according to claim 6, wherein the slot liner extends axially from the first end face so as to be received by the annular sealing member.

8. The electric machine according to claim 1, wherein the axially-facing surface is connected to the first end face by an adhesive.

9. The electric machine according to claim 1, wherein the annular sealing member comprises a thermoplastic material such as PEEK.

10. The electric machine according to claim 1, wherein the drain passage is arranged between the annular sealing member and the stator core.

11. A stator assembly for an electric machine, the stator assembly comprising:
a stator core disposed around a longitudinal axis, the stator core comprising an annular back iron, a stator bore, and a plurality of teeth extending radially toward the longitudinal axis, the plurality of teeth defining a plurality of stator slots configured to receive a plurality of windings, and
an annular sealing member comprising:
an axially-facing surface arranged against a first end face of the stator core, the axially-facing surface defining openings aligned with the plurality of stator slots, the openings being configured to receive at least one end winding of the plurality of windings,
a radially-facing surface extending away from the first end face, so as to be able to seal against one or more structural members of the electric machine when assembled therewith, and
a drain passage configured to allow coolant in the stator bore to flow radially outwards past the annular sealing member.

12. The stator assembly according to claim 11, wherein a gap between at least one adjacent pair of the plurality of teeth comprises a varnish.

13. The electric machine according to claim 1, further comprising a second annular sealing member arranged at a second end face of the stator core, the second end face being on the opposite end of the stator core to the first end face, and wherein the second annular sealing member comprises:
a second axially-facing surface arranged against the second end face, the second axially-facing surface defining second openings aligned with the plurality of stator slots, the second openings being configured to receive at least one end winding of the plurality of windings, and
a second radially-facing surface extending away from the second end face, so as to be able to seal against the one or more structural members of the electric machine when assembled therewith.

14. An annular sealing member for the stator assembly of claim 11, the annular sealing member comprising:
an axially-facing surface configured to be disposed against a first end face of the stator core, the axially-facing surface defining openings configured to align with the plurality of stator slots,
a radially-facing surface configured to extend away from the first end face, so as to be able to seal against one or more structural members of the electric machine when assembled therewith, and
a drain passage configured to allow coolant in the stator bore to flow radially outwards past the annular sealing member.

15. An aircraft comprising the electric machine of claim 1.

16. The electric machine according to claim 1, wherein the air gap has a radial length of less than 0.9 mm.

17. The electric machine according to claim 1, wherein the air gap has a radial length of less than 0.8 mm.

18. The electric machine according to claim 1, wherein the air gap has a radial length of than 0.7 mm.

19. The stator assembly according to claim 11, further comprising a second annular sealing member arranged at a second end face of the stator core, the second end face being on the opposite end of the stator core to the first end face, and wherein the second annular sealing member comprises:
a second axially-facing surface arranged against the second end face, the second axially-facing surface defining second openings aligned with the plurality of stator slots, the second openings being configured to receive at least one end winding of the plurality of windings, and
a second radially-facing surface extending away from the second end face, so as to be able to seal against the one or more structural members of the electric machine when assembled therewith.
